(19) United States
(12) Patent Application Publication
(10) Pub. No.: US 2021/0081894 A1
(43) Pub. Date: Mar. 18, 2021

(54) CONSTRAINED VEHICLE ROUTING USING CLUSTERS

(71) Applicant: NEC Laboratories Europe GmbH, Heidelberg (DE)

(72) Inventors: Francesco Alesiani, Heidelberg (DE); Gulcin Ermis, Heidelberg (DE)

(21) Appl. No.: 16/570,018

(22) Filed: Sep. 13, 2019

(51) Int. Cl. G06Q 10/08; G01C 21/34; G05D 1/00; G06Q 50/30; G06F 11/07

(52) U.S. Cl. CPC G06Q 10/08355; G01C 21/343; G06F 11/0709; G05D 1/0022; G06Q 50/30; G05D 1/0027

(57) ABSTRACT

A method of performing constrained vehicle routing includes representing variables in an embedded space. The variables are clustered such that cluster elements are compatible with one another. A constrained vehicle routing problem is solved at a level of the clusters. The constrained vehicle routing solution at the level of the clusters is expanded to a level of the variables. Each tour of the constrained vehicle routing solution expanded to the level of the variables is separately refined.

### FIELD

The present invention relates to an improved method for determining constrained vehicle routing solutions using clusters of nodes.

### BACKGROUND

A capacitated vehicle routing problem (VRP), which is a type of constrained vehicle routing problem, can include a fleet of vehicles serving multiple clients subject to the following constraints: each vehicle must originate from and return to a specified depot; each vehicle has a limited capacity; the clients are distributed across multiple locations; and each client has a need that involves an object being delivered from or to the depot with one of the vehicles. K. Bujel et al., “Solving High Volume Capacitated Vehicle Routing Problem with Time Windows Using Recursive-DBSCAN Clustering Algorithm”, ArXiv:1812.02300 [Cs] (Dec. 5, 2018), which is hereby incorporated by reference herein in its entirety, discuss a capacitated vehicle routing problem. Bujel et al. propose a geometrical clustering algorithm that outperforms the Google OR-tool in solving the capacitated VRP with time windows by performing well on a graph size of 5,000 versus 2,000 nodes. The graph of Bujel et al., however, is still limited to 5,000 nodes and cannot consider solutions which do not have geometrical properties, such as the case when connections are not available among nodes.

### SUMMARY

In an embodiment, the present invention provides a method of performing constrained vehicle routing. The method includes representing variables in an embedded space. The variables are clustered such that cluster elements are compatible with one another. A constrained vehicle routing problem is solved at a level of the clusters. The constrained vehicle routing solution at the level of the clusters is expanded to a level of the variables. Each tour of the constrained vehicle routing solution expanded to the level of the variables is separately refined.

### BRIEF DESCRIPTION OF THE DRAWINGS

Embodiments of the present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically depicts an exemplary constrained vehicle routing problem including original nodes;

FIG. 2 schematically depicts an exemplary ultimate or original-node-level solution to the constrained vehicle routing problem of FIG. 1;

FIG. 3 schematically depicts an exemplary grouping of the original nodes in FIG. 1 into clusters and computation of surrogate nodes based on the clusters;

FIG. 4 schematically depicts an exemplary surrogate routing solution based on the surrogate nodes of FIG. 3;

FIG. 5 schematically depicts an exemplary intermediate original routing solution determined based on the exemplary surrogate routing solution of FIG. 4;

FIG. 6 is a block diagram of an exemplary method of constrained vehicle routing, which can include the activity illustrated in FIGS. 1-5;

FIG. 7 is a block diagram of an exemplary processing system; and

FIG. 8 is a block diagram of an exemplary method of constrained vehicle routing, which can include the activity illustrated in FIGS. 1-5.

### DETAILED DESCRIPTION

Embodiments of the present invention group nodes (which can also be referred to as “variables”) of a constrained vehicle routing problem into clusters, find a constrained vehicle routing solution over the clusters, then map the cluster-level solution to the original nodes. By doing so, embodiments of the present invention offer at least the following improvements over existing computer systems configured to implement constrained vehicle routing techniques. First, the embodiments increase the size of solvable constrained vehicle routing problems. For example, the embodiments can perform constrained vehicle routing over more nodes than previously possible, improving application scalability, the number of potential applications, and application flexibility. Second, the embodiments can improve the quality and accuracy of constrained vehicle routing solutions. Third, the embodiments increase computational efficiency of the computer systems and computer networks which are configured to be used for determining routing decisions, thereby reducing one or both of (i) the time needed to generate a solution and (ii) the volume of computational resources required to generate a solution.

Constrained vehicle routing falls in the complexity class of non-deterministic polynomial time hardness (“NP-hardness”), meaning that the average and/or maximum number time required to compute a solution to a constrained vehicle routing problem exhibits a superpolynomial (e.g., exponential) relationship to the number of nodes. Put differently, as the number of nodes increases linearly, the time (e.g., average or maximum) required to find a solution to a constrained vehicle routing problem involving the nodes increases superpolynomially (e.g., exponentially). Time can serve as a proxy for the number of operations that a processing system must perform to compute a solution.

Existing heuristics can perform constrained vehicle routing in a computationally efficient manner only when the total count of nodes is limited to approximately one hundred. A. Florian et al., “Efficiently Solving Very Large-Scale Routing Problems”, Computers & Operations Research 107, 32-42 (July 2019), which is hereby incorporated by reference herein in its entirety, proposes exploration heuristics to perform constrained vehicle routing, but only on node counts up to the fifth order of magnitude (i.e., between one-hundred and one-hundred-thousand).

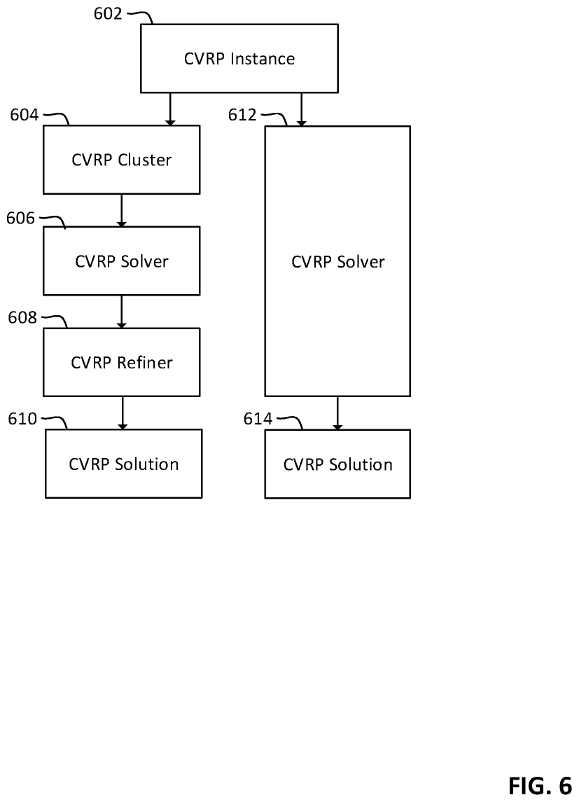

In an embodiment, the present invention applies clustering to increase the size (e.g., node count or original node count as discussed below) of solvable constrained vehicle routing problems. For example, and as shown in FIG. 6, a processing system can receive an original constrained vehicle routing problem (“CVRP”) including multiple original nodes (also called “variables”—examples of original nodes include customer locations), original constraints (e.g., each customer location must be visited by at least one tour), and original criteria (e.g., a solution must minimize or maximize a dimension aggregated across the tours) at block 602.

Through preprocessing at block 604, the processing system can generate a surrogate constrained vehicle routing problem (also called a “cluster-level problem”) based on the original constrained vehicle routing problem (also called an “original-node-level problem” or a “variable-level problem”). The surrogate problem can include surrogate nodes, surrogate constraints, and surrogate criteria. In an embodiment, the surrogate constraints and surrogate criteria are based on (e.g., identical to) the original constraints and the original criteria.

During preprocessing (also called “clustering” or “grouping”), the processing system can group original nodes into clusters based on dimensions (also called “features”) of the original nodes (e.g., geographical coordinates). Representatives (also called “cluster heads” such as weighted averages) of the clusters can define the locations of surrogate nodes.

At block 606, the processing system can apply a constrained vehicle routing algorithm (also called a “solver”) at the cluster-level instead of at the original-node level. Because there are fewer clusters than original nodes, computation of the surrogate routing solution (also called a “cluster-level routing solution”) can offer a superpolynomial (e.g., exponential) complexity reduction over application of the same constrained vehicle routing algorithm or solver at the original-node level. Examples of solvers include the Clarke-Wright Algorithm, genetic algorithms, Ant Colony or formulating the problem as Integer Linear Programming (ILP) and solving with a Mixed Integer Linear Programming (MILP) solver. Another constrained vehicle routing algorithm which could be used according to an embodiment of the present invention could follow the following exemplary steps:

1. Assign a tour to each customer.

2. Randomly select two tours.

3. For each of these two tours select one or more customer to exchange.

4. Compute the saving in: exchanging the customers between the two tours or merging the tours.

5. Select the most convenient action.

6. Assign tours to vehicles.

7. Stop the iteration if some conditions are met.

Depending on the problem definition, the foregoing steps 1-7 can be adjusted accordingly.

After solving the surrogate or cluster-level problem, the processing system can map (also called “expand” or “extend”) the surrogate constrained vehicle routing solution to the original nodes to create an extended constrained vehicle routing solution at block 608. The extended vehicle routing solution can be at the original node-level instead of at the cluster-level. The mapping can be linear or nonlinear. The extended vehicle routing solution (also called an “intermediate extended vehicle routing solution”) can be refined, at block 608, to produce a refined and extended constrained vehicle routing solution (also called an “ultimate extended vehicle routing solution”) at block 610.

Referring to FIG. 6, existing solutions omit clustering, extending, and refining processes, thus requiring the vehicle routing problem solver at block 612 to function at the original-node level instead of at the cluster-level when producing a vehicle routing solution at block 614. As a result of the superpolynomial complexity reduction associated with clustering, embodiments of present invention enable constrained vehicle routing on original node counts exceeding the fifth order of magnitude (e.g., hundreds of thousands, millions, etc.). Furthermore, embodiments of the present invention enable higher quality or more accurate solutions and increased computational efficiency, thereby reducing the time required to identify a solution and/or the number of computational resources that must be devoted to identify a solution.

According to an embodiment of the invention, a method for clustering variables in a constrained vehicle routing problem can include:

(1) Defining a representative for each variable (e.g., customer) in an embedded space. The representative in some embodiments can be coordinates (also called an “embedding”) of a node corresponding to the variable.

(2) Iteratively clustering variables such that the cluster elements are compatible among the clustered variables. For example, variables can be grouped such that certain features (e.g., node coordinates) are compatible within each cluster of variables.

(3) Iteratively updating the representative of each cluster (e.g., a cluster head) based on the elements that belong to the cluster (e.g., the nodes serving as members of the respective cluster).

(4) Solving the constrained vehicle routing problem at the cluster level.

(5) Expanding the cluster-level solution to the original nodes and refining the expanded solution for each tour. Each tour of the expanded solution can be refined separately and in-parallel.

In an embodiment, the cost is the Euclidian distance and the embeddings are the coordinates in plane geometry. According to another embodiment, if the cost is more complex, then a feature vector is used for each customer and a cost function, such that the two vectors of two customers and the cost function are applied, the result is the cost between the two customers. This advantageously avoids to have to store in memory an n² matrix, where n is the number of customers. When the number of customer is large as, for example 140,000, the matrix alone would be too large to store.

In an embodiment, compatibility is based on the evaluation of the constraints. One example is the capacity of the vehicle: more customers are not allowed if the capacity of the cluster exceeds the vehicle capacity.

In an embodiment, the method includes iteratively assigning customers (e.g., original nodes each having coordinates based on a feature, such as location, of the respective customer) to clusters. During each iteration, a representative of each cluster (e.g., a cluster head) can be updated based on the new cluster membership (e.g., the updated set of original nodes forming the cluster). During a subsequent iteration, original nodes can be reassigned across clusters based on (i) a distance between each respective original node and each respective cluster representative and/or (ii) feasibility among already assigned original nodes.

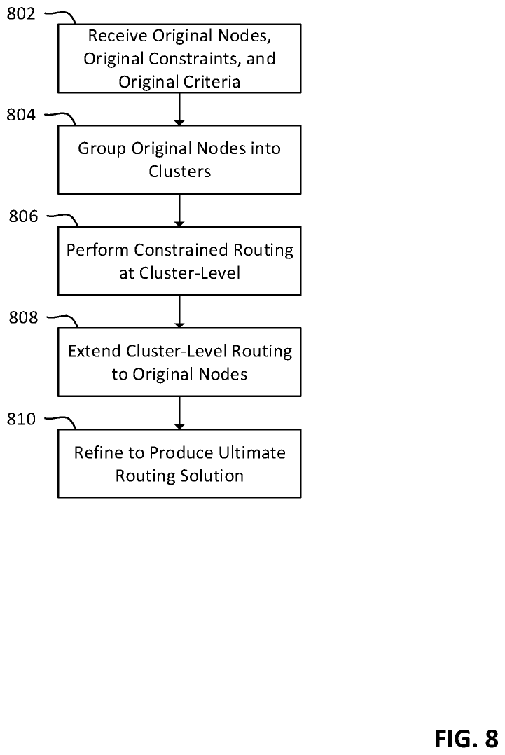

FIG. 8 illustrates an embodiment of the present invention. At block 802, a processing system can receive a vehicle routing problem containing original nodes, original constraints, and original criteria. At block 804, the processing system can group the original nodes into clusters based on compatibility (e.g., based on the compatibility of the original nodes within a respective cluster). At block 806, the processing system can apply a solver to find a cluster-level constrained vehicle routing solution. At block 808, the processing system can extend the cluster-level constrained vehicle routing solution to the original nodes. At block 810, the processing system can refine the extended solution to produce a refined and extended constrained vehicle routing solution (also called an “ultimate routing solution”).

In an embodiment, the present invention provides a method of performing constrained vehicle routing. The method includes representing variables in an embedded space. The variables are clustered such that cluster elements are compatible with one another. A constrained vehicle routing problem is solved at a level of the clusters. The constrained vehicle routing solution at the level of the clusters is expanded to a level of the variables. Each tour of the constrained vehicle routing solution expanded to the level of the variables is separately refined.

In the same or another embodiment, the clustering the variables is performed iteratively and includes iteratively updating a representative of each cluster based on the cluster elements that belong to the respective cluster.

In the same or another embodiment, the clustering the variables is performed iteratively and includes: for each cluster, computing a representative of the cluster based on features of the variables belonging to the cluster; revising cluster membership of the variables based on the cluster representatives; and for each revised cluster, computing an updated representative based on features of the variables belonging to the revised cluster.

In the same or another embodiment, the representative of each cluster is computed based on coordinates of the variables belonging to the respective cluster.

In the same or another embodiment, the representative of each cluster is a cluster head having coordinates equal to a weighted average of the coordinates of the variables belonging to the respective cluster.

In the same or another embodiment, the constrained vehicle routing solution at the level of the clusters comprises multiple tours, each of the tours beginning and ending with a hub and comprising, therebetween, one or more surrogate nodes.

In the same or another embodiment, each of the surrogate nodes maps to a respective one of the clusters.

In the same or another embodiment, the constrained vehicle routing solution expanded to the level of the variables comprises multiple tours each beginning and ending with the hub and comprising, therebetween, one or more of the variables.

In the same or another embodiment, separately refining each tour of the constrained vehicle routing solution expanded to the level of the variables comprises refining each of the tours in parallel.

In the same or another embodiment, the method includes generating instructions for routing vehicles based on the refined constrained vehicle routing solution, wherein an amount of the variables is greater than one hundred thousand.

In the same or another embodiment, the method includes controlling one or more vehicles based on the generated routing instructions, wherein each of the vehicles is selected from a group consisting of: drones, trucks, buses, airplanes, trains, and boats.

In the same or another embodiment, the method includes controlling a fleet of autonomous drones based on the generated routing instructions.

In the same or another embodiment, the method includes scheduling execution of computational tasks (i) across a high-performance computer cluster and/or (ii) across a graphics processing unit based on the generated routing instructions.

In another embodiment, the present invention provides a processing system comprising one or more processors, which alone or in combination, are configured to provide for execution of a method comprising: representing variables in an embedded space; clustering the variables such that cluster elements are compatible with one another; solving a constrained vehicle routing problem at a level of the clusters; expanding the constrained vehicle routing solution at the level of the clusters to a level of the variables; and separately refining each tour of the constrained vehicle routing solution expanded to the level of the variables.

In a further embodiment, the present invention provides a tangible, non-transitory computer-readable medium having instructions thereon which, upon being executed by one or more processors, alone or in combination, provide for execution of any of the methods according to embodiments of the invention described herein.

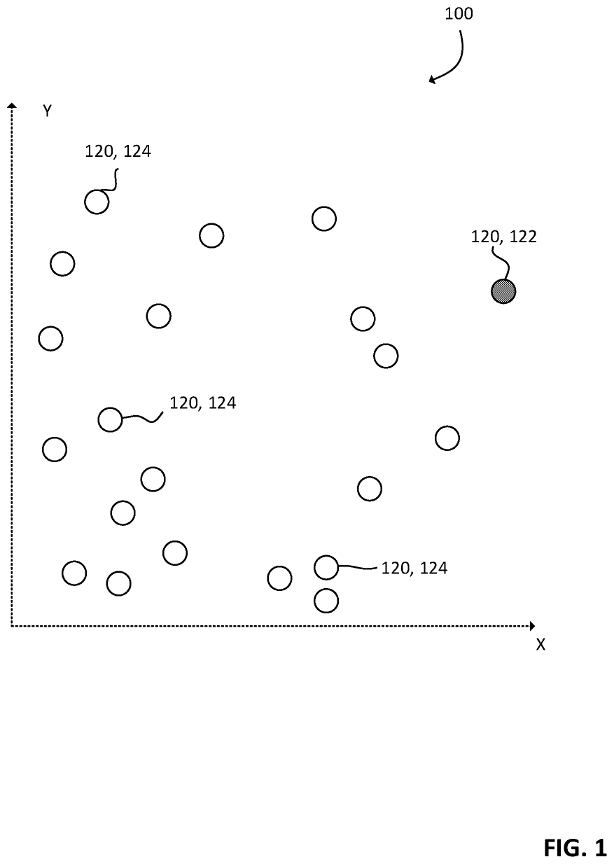

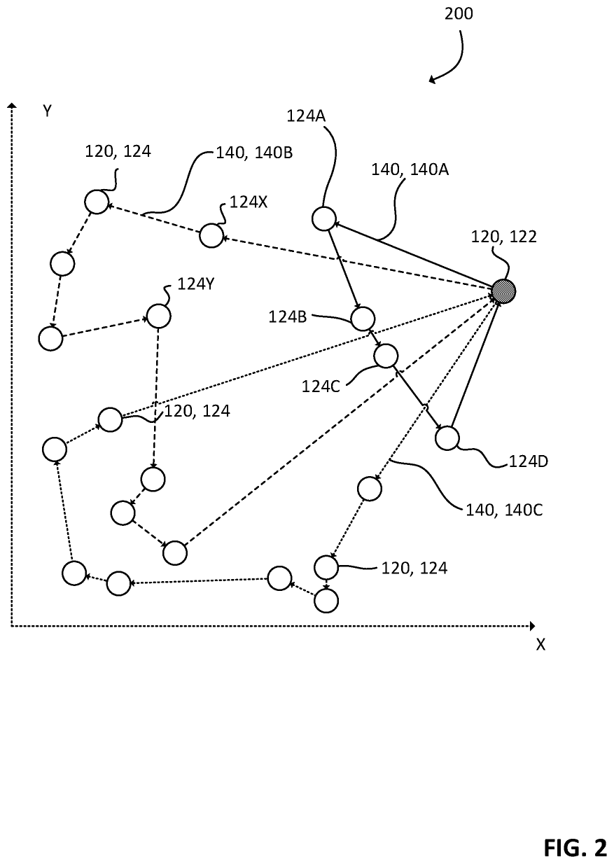

FIG. 1 schematically illustrates a constrained vehicle routing problem 100 involving original nodes 120, original constraints, and original criteria. FIG. 2 schematically illustrates a constrained vehicle routing solution 200 to problem 100. Referring to FIGS. 1 and 2, original nodes 120 can have coordinates (X-Y coordinates as shown). Original nodes 120 can represent, for example, locations for delivering and/or picking up goods. As further discussed below, original nodes 120 can include one or more original hub nodes 122 and one or more original client nodes 124.

Referring to FIG. 2, a solution to constrained vehicle routing problem 100 can include a set of tours 140 (also called “routes”) satisfying the following original constraints: (a) each tour 140 must begin and end at an original hub node 122 and (b) each of the original client nodes 124 must be visited by at least one tour 140. Many other constraints can be enforced. For example, if the tours represent vehicle delivery routes, then constraints may involve limited vehicle package capacities, limited vehicle fuel capacities, timing, etc. As further discussed below, the processing system can automatically control multiple autonomous vehicles based on tours 140. For example, the processing system can automatically instruct each of a plurality of autonomous vehicles to follow a respective tour 140.

Solution 200 of FIG. 2 observes constraints (a) and (b) via first tour 140A, second tour 140B, and third tour 140C. For clarity, each tour 140 is indicated with a different line type: solid, broken-dashed, or broken-dotted. First tour 140A includes the following ordered set: original hub node 122, first original client node 124A, second original client node 124B, third original client node 124C, fourth original client node 124D, original hub node 122. Second and third tours 140B, 140C are correspondingly structured.

In an embodiment, each tour 140 represents the route of a vehicle and each node 120 represents a stop along a route where the vehicle interacts with a customer (e.g., the vehicle accepts or delivers an object). As stated above, the processing system can cause each vehicle (which can be autonomous) to observe tours 140. For example, the processing system can instruct a first vehicle (e.g., drone, bus, car, boat, etc.) to follow first tour 140A, a second vehicle to following second tour 140B, and a third vehicle to follow third tour 140C. Alternatively, and as previously discussed, each tour 140 can represent the path of a piece of data in a processing system (e.g., across a network).

A constrained vehicle routing problem 100 can include criteria for evaluating potential solutions, meaning solutions that satisfy all of the constraints. Criteria can be narrow or broad. Narrow criteria can require a global maximization or minimization of a property in which case only a single ultimate solution may exist, where an ultimate solution satisfies each of the constraints and the criteria. Referring to the examples of FIGS. 1 and 2, criteria could require the global minimization of the aggregated tour lengths to minimize total distance traveled. In an embodiment, constrained vehicle routing solution 200 of FIG. 2 is an ultimate solution to the constrained vehicle routing problem 100 of FIG. 1.

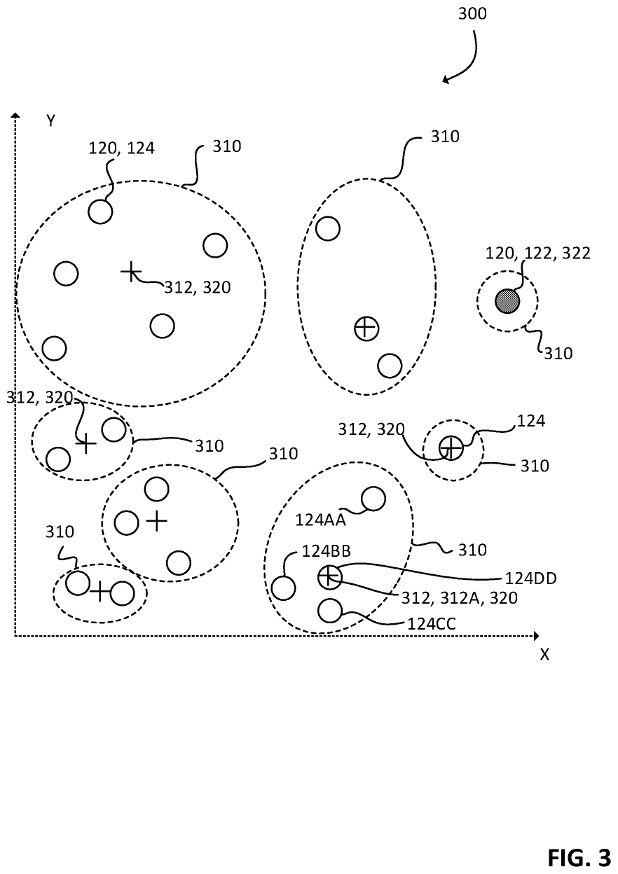

FIGS. 3-5 schematically show stages of a method of determining a constrained vehicle routing solution given a constrained vehicle routing problem. The examples of problem 100 and solution 200 are used for the purposes of illustration.

Referring to FIG. 3, a processing system can group original nodes 120 into clusters 310. Processing system can cluster original nodes 120 based on features such as distance, compatibility, and original constraints. Only some of original nodes 120 may be clustered or some clusters can consist of a single original node 120.

The processing system can compute a head 312 (also called a “representative”) for each cluster. Each cluster head 312 can have coordinates equal to the weighted average of the original nodes 120 forming the respective cluster. For example, cluster head 312A can have coordinates equal to the coordinated weighted average of the client nodes 124AA, 124BB, 124CC, and 124DD.

The processing system can assign a respective surrogate node 320 to each cluster 310 based on the cluster head or representative. For example, the processing system can assign a respective surrogate node 320 to each cluster such that the respective surrogate node 320 has coordinates equal to the cluster head. By virtue of being alone, original hub node 122 can have the same coordinates as surrogate hub node 322. In embodiments with multiple hub nodes 122 where each original tour can begin and end at any thereof, the multiple hub nodes 122 can be grouped into one or more (e.g., a single) surrogate hub clusters. The collection of surrogate nodes 320 including surrogate hub node 322, in addition to surrogate constraints, can define a surrogate constrained vehicle routing problem 300.

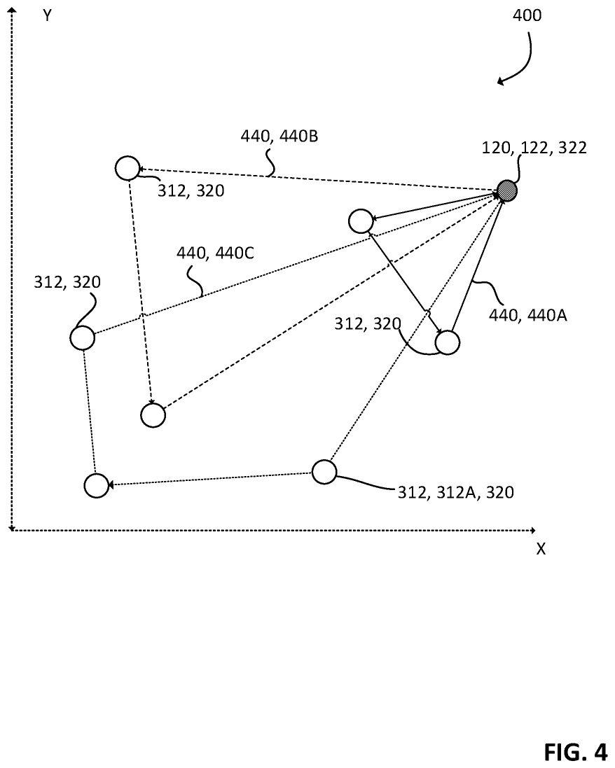

Referring to FIG. 4, the processing system can apply a solver to identify a constrained vehicle routing solution 400 to surrogate constrained vehicle routing problem 300. The surrogate problem 300 can involve surrogate nodes 320, surrogate constraints, and surrogate criteria. The surrogate constraints and criteria can be based on (e.g., identical to) the original constraints and criteria. Surrogate solution 400 can include multiple surrogate tours 440 each composed of an ordered set of surrogate nodes beginning an ending with surrogate hub node 322. As discussed above, surrogate hub node 322 can map to one or more original hub nodes 122. In an embodiment, each surrogate tour 440 is mapped to a respective original node tour 140. Therefore, FIG. 4 shows three surrogate tours 440A, 440B, 440C, which is equal to the number of original node tours 140.

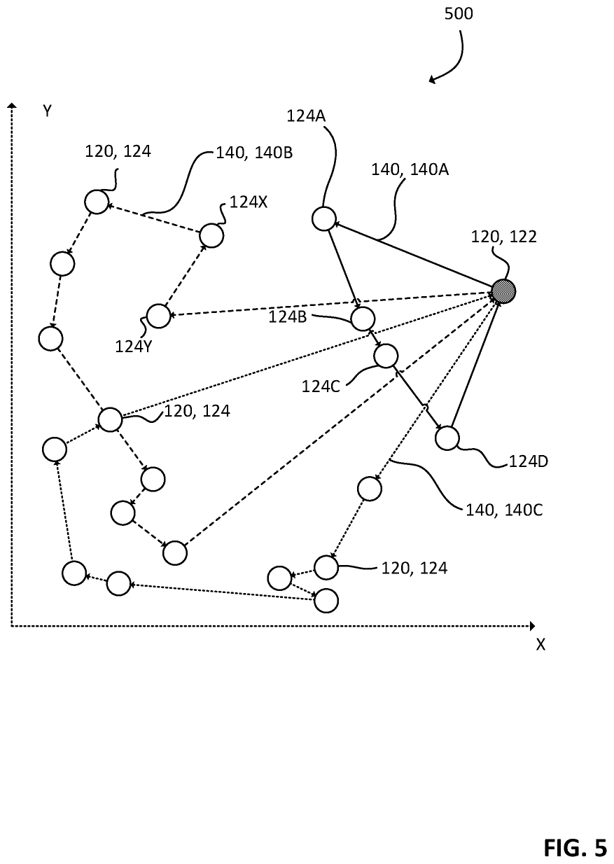

Referring to FIG. 5, the processing system can map the surrogate solution 400 onto original nodes 120 to create an extended solution 500 (also called an “intermediate solution”) having original node tours 140. The processing system can refine the extended solution 500 until obtaining ultimate solution 200. In an embodiment, refinement occurs with respect to each original node tour 140 separately such that multiple (e.g., all) original node tours 140 can be refined in parallel or simultaneously. When refined separately, the membership of each original node tour 140 can be maintained while the order is adjusted. For example, second original node tour 140B of extended solution 500 orders node 124Y before node 124X while second original node tour 140B of extended solution 200 orders node 124Y after node 124X.

In an embodiment, the clustering formation and the determination of the ultimate solution are integrated. First, customers (e.g., original nodes) can be assigned to a cluster. Second, a surrogate node can be assigned to each cluster. Third, tours can be computed based on the surrogate nodes. Each tour can represent the route of a vehicle. Fourth, tours can be improved via cross over, ejection chain, or 2-tour connection (savings) heuristics. Fifth, a single tour can be improved. For example, each tour can be separately refined in parallel.

In an embodiment, the processing system can conduct the clustering or grouping process as described below. First, based on the number of customers (e.g., client nodes), the demand, and capacity of the vehicles performing the tours, initial cluster dimensions are defined. Dimensions can include a number of clusters, a distance threshold, and a capacity threshold. Distance threshold can be the maximum allowable distance from a cluster head to any original node within the cluster. As previously described, a cluster head can have coordinates equal to the weighted average of all original nodes forming a cluster.

Second, for each customer (e.g., original node), the distances to the cluster heads can be computed. During an initial stage, cluster heads can be generated randomly, for example by selecting k random customer locations, where k is the number of clusters. Then, it is possible to compute the distances. Third, the customers can be ordered such that the nearest cluster is considered first. Fourth, each customer can be assigned to a cluster if the customer is compatible with the currently considered cluster. In an embodiment, the following constraints are observed: (a) the cluster accumulated demand plus the new customer cannot exceed a predetermined value; (b) the distance of a customer within a cluster to the cluster head cannot exceed a predetermined value; and (c) other constraints related to the current customer and previously assigned customers cannot be violated such as opening time, object compatibility, etc.

Sixth, the cluster head locations can be updated to account for the new customers. The update can average the position of each customer assigned to the cluster according to the following equation where Sᵢ^{t} is the set of customers at time “t” for cluster “i” and “x” is the location of the customer.

$${μ}_{i}^{t + 1} = \frac{{1}^{X}}{{\vert {S}_{i}^{t} \vert}_{x 2 {S}_{i}^{t}}} x$$

where x represents the location of the nodes (e.g., customer location) in the set of nodes that belong to the current cluster Sᵢ^{t}, where t is the iteration index, i is the cluster id.

Seventh, the customers can be considered according to distance to the next available cluster head. The clustering process can be iterative such that the fourth, fifth, and sixth parts are repeated until covergence occurs (e.g., cluster head coordinates and/or cluster sets do not change or change less than a predetermined value).

To define the order of evaluation of customers, a priority queue can be established. In an embodiment, a method assumes that each customer has a location when only the distance is known among customers. A proper embedding can then be computed in a dimension “k”. Dimension “k” can be derived based on an error function of the representation power of the embeddings of the distance matrix. The first expession shown below is an error function. The second expression shown below is an error minimization function.

$$d ( i , j ) \approx d ( {e}_{i} , {e}_{j} )$$

$${min}_{e} \vert d ( i , j ) - d ( {e}_{i} , {e}_{j} ) \vert$$

where eᵢ and eⱼ are the embeddings or coordinates.

The foregoing problem can also be referred to as multi-dimensional scaling (MDS).

To improve performance, a “mini-batch” version can be considered where clusters are updated only considering a subset of customers per iteration. Further, a tree structure (e.g., a KDTree) can be constructed at each iteration on the cluster heads to improve performance by evaluating the closest cluster head to each customer. To minimize complexity and enable parallelization, each tour can be independently refined as previously discussed.

In an embodiment, demand and travel time (or any other variable(s)) can be uncertain. The following cases are considered: First, where the demand and travel time are of bounded variation dᵢ≤dᵢ≤d̅ᵢ, tᵢⱼ≤tᵢⱼ≤t̅ᵢⱼ. In this case, the information used can be the worst-case scenario: dᵢ=d̅ᵢ tᵢⱼ=t̅ᵢⱼ. Second, the demand and travel time are estimated with variance (e.g., standard deviation) information associated thereto. In this case, the information used can be the mean plus the standard deviation: dᵢ=\hat{d}ᵢ+σᵢ tᵢⱼ=\hat{t}ᵢⱼ+σᵢⱼ. Third, where the information is available via an unknown distribution: tᵢⱼ˜pᵢⱼ, dᵢ˜pᵢ. In this case, the clustering can be performed based on the expected value or the worst case of a Monte Carlo Simulation conducted against the existing or generated samples. In a constraint check associated with this embodiment, the variables can be sampled and the constraint can be checked against the single realization or the average. In any of the above cases, the subsequent problem can be solved where the uncertainty or variability of any given variable (e.g., original node) is propogated to the cluster where the variable belongs.

Embodiments of the invention offer at least the following advantages: First, the embodiments can be used in conjunction with existing CoVRP/CVRP solvers. Second, the embodiments apply a surrogate problem to reduce the count of nodes, thus decreasing problem complexity and increasing the size of solvable problems. Third, the embodiments offer paralleizable refinement.

In an embodiment, the invention can be applied to parcel collection and delivery. The cluster assignment can consider the vicinity of customers, parcel volume/weight, and vehicle volume capacity/weight capacity. Cluster assignment can be performed to fit the smallest available truck (e.g., the vehicle with the smallest capacity). When opening time of the customer is available, the parcels can be grouped such that their opening time and the travel time between successive customers is compatible. Since by itself this is a combinatorial problem the additional customer is visited following the last added customer to the cluster, plus the return time to the closest depot.

Embodiments of the invention can be applied to drone surveillance. An area of interest can be divided into a grid. Each intersection on the grid can represent an original node. Each node can require a certain amount of surveillance (e.g., be visited exactly or at least one). Clustering can be perfomed on the basis of both node vacinity and battery capacity. Each tour can end with a return to a predetermined charging location. If the location requires different level of detail (e.g., height of the survey on that node) than the distance includes the change in height so that the drone would fly at the constant height. After the clustering the VRP problem can be solved where the clusters of node will have additional information as the total height variation, battery discharge and travel time. The solution can then refined for each drone on the customers belonging to the clusters assigned to the drone.

A constrained vehicle routing solution computed by the processing system can be automatically applied to control vehicles in at least the following domains in which constrained vehicle routing problems arise:

(1) eCommerce/postal/waste services where objects (e.g., packages, waste, etc.) must be delivered to and/or picked up from multiple locations. In this domain, the multiple locations can represent the original nodes (i.e., each location can be a respective individual node). A respective vehicle can autonomously drive (e.g., fly) along each tour of the ultimate, original node-level, routing solution based on instructions that the processing system automatically delivers.

(2) Drone-based surveillance/farming/cleaning where a fleet of drones must coordinate patrols (e.g., monitoring an area, spreading seeds over an area, cleaning an area, etc.) with recharging to minimize downtime associated with each sub-area. As previously discussed, nodes can be assembled by overlying a grid onto an area and designating each grid vertex as an original node. A respective vehicle (e.g., drone) can autonomously drive (e.g., fly) each tour of the ultimate routing solution based on instructions that the processing system automatically delivers.

(3) High performance computing clusters where tasks with varying priorities must be executed across cluster of computers constrained by communication delay, bounded capacity of elaboration, and memory requirements. The original nodes can represent the tasks and each tour of the ultimate routing solution can represent a respective high-performance computing cluster. As with all solutions disclosed herein, the high-performance computing cluster (i.e., the resources configured to implement the tours) can be configured to automatically implement the ultimate tours (i.e., operate based on the tours) based on instructions that the processing system automatically generates and delivers.

(4) Graphical computation where minor tasks are spread across multiple processing units each with limited capacity, where a relationship exists among tasks and communications between the processing units are delayed. Each task can map to a respective original node and each processing unit can map to a respective ultimate tour.

(5) Public transport where buses, airplanes, trains, and other vehicles are routed to maximize specified objectives (e.g., passenger transport time, fuel efficiency, etc.). As discussed in detail above, each of these vehicles can map to a respective ultimate tour such that each vehicle is autonomously or manually controlled (e.g., routed) based on the ultimate tour. Each node can represent a stop along a route (e.g., a passenger/package pick-up or a passenger/package drop-off).

The foregoing applications of constrained vehicle routing solutions have in common that computational efficiencies can be achieved in accordance with embodiments of the present invention as discussed above. While, in some embodiments, the tours refer to routes of information and not necessarily to routes of vehicles along roads or the like, the use of the term constrained vehicle routing applies equally to each of these embodiments.

Embodiments of the present invention are complementary to existing heuristics and can be applied to existing solvers. Put differently, existing constrained vehicle routing solutions (e.g., software) can be retrofitted based on the features disclosed herein. Embodiments of the present invention enhance the size of solvable problems. For example, in an embodiment, the present invention can generate a constrained vehicle routing solution to a problem including 140,000 variables (e.g., original nodes) in a few seconds, which would be impossible with existing methods due to computational complexity and memory requirements.

Table 1 below presents partial results, illustrating the advantage in time and performance an embodiment of the present invention enables for constrained vehicle routing problems. The existing solver is Google OR-TOOLS. The embodiment of the invention applies the existing solver (i.e., Google OR-TOOLS) to the surrogate or cluster-level problem then, consistent with the above disclosure, expands the cluster-level solution to the original node-level and then refines the expansion to produce the ultimate, original node-level, solution. A timeout of 100 s was used for the existing solver.

Existing solver time (“Existing Time”) lists the time (in seconds (“s”)) required for the existing solver to compute an original-node-level solution on the instance. Embodiment time (“Embd. Time”) lists the time (in seconds) required for the embodiment to compute an original-node-level (i.e., ultimate) solution on the instance. The embodiment time includes clustering, applying the existing solver to the clusters, expanding the surrogate solution to the original nodes, and refinement. Speed improvement (“Speed Imprv.”) compares embodiment time against existing solver time. Quality degradation (“Quality Deg.”) compares embodiment quality against existing solver quality. A negative quality degradation indicates that the embodiment exhibits a quality improvement over the existing solution. For some instances (i.e., data sets of original nodes), the embodiment produces a higher quality solution (up to 15.5% improvement) at a faster computational speed (a speed improvement of up to 81%).

TABLE 1

| | Quality | Speed | Existing | Embd. | Original |
|---|---|---|---|---|---|
| | Deg. | Imprv. | Time | Time | Node |
| Instance Name | (%) | (%) | (s) | (s) | Count |
| A-n32-k5.vrp | 0.01 | 58.8 | 0.04 | 0.02 | 32 |
| A-n80-k10.vrp | 1.23 | −6.3 | 0.29 | 0.31 | 80 |
| P-n101-k4.vrp | −8.76 | 56.5 | 0.36 | 0.16 | 101 |
| B-n64-k9.vrp | −15.5 | 50.7 | 0.16 | 0.08 | 64 |
| B-n57-k9.vrp | −2.26 | 8.8 | 0.1 | 0.09 | 57 |
| X-n313-k71.vrp | 5.42 | 81.2 | 7.85 | 1.48 | 313 |
| X-n120-k6.vrp | 9.67 | 71.7 | 0.56 | 0.16 | 120 |
| X-n190-k8.vrp | 0.67 | 76.3 | 1.68 | 0.4 | 190 |
| X-n223-k34.vrp | −0.25 | 17.3 | 2.41 | 2 | 223 |
| X-n979-k58.vrp | −0.21 | 65.5 | 54.74 | 18.9 | 979 |
| X-n449-k29.vrp | 1.27 | 75.7 | 8.37 | 2.04 | 449 |
| X-n819-k171.vrp | 0.77 | 19.6 | 31.2 | 25.08 | 819 |
| Leuven1.vrp | 0.06 | −0.4 | 100 | 100.4 | 3000 |
| Leuven2.vrp | −3.42 | −3.3 | 100 | 103.3 | 4000 |
| Antwerp1.vrp | 0.56 | −0.9 | 100.1 | 101 | 6000 |
| Antwerp2.vrp | −2.01 | −2.8 | 100 | 102.8 | 7000 |
| Ghent1.vrp | 3.87 | −6.6 | 100.1 | 106.7 | 10000 |
| Ghent2.vrp | 0.13 | 7.5 | 100.1 | 92.62 | 11000 |
| Brussels1.vrp | N/A | N/A | N/A | 103.9 | 15000 |
| Brussels2.vrp | N/A | N/A | N/A | 131.9 | 16000 |
| Flanders1.vrp | N/A | N/A | N/A | 111.6 | 20000 |
| Flanders2.vrp | N/A | N/A | N/A | 185 | 30000 |

Above eleven-thousand original nodes (i.e., clients or customers), the existing solver stops returning results. Although not present in FIG. 8, the embodiment was applied to a problem instance called “Instance_140k.vrp”. Time spent grouping was 46.8 s, which resulted in 22,541 clusters. Time spent to achieve an ultimate solution after clustering was 223 s. The count of original nodes was 142,298.

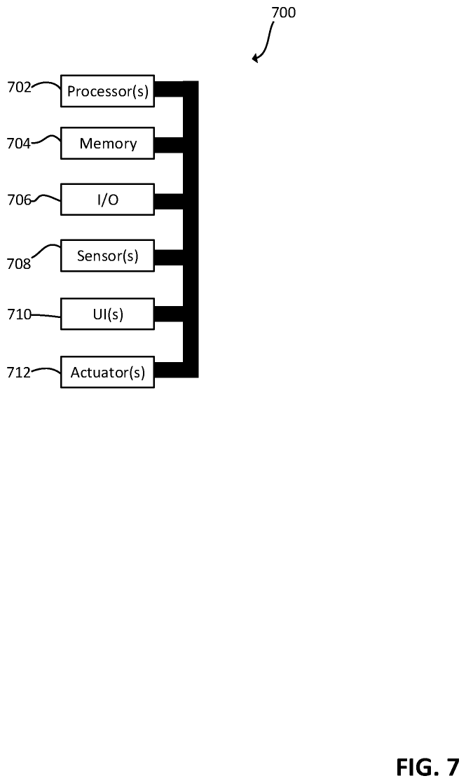

Referring to FIG. 7, a processing system 700 can include one or more processors 702, memory 704, one or more input/output devices 706, one or more sensors 708, one or more user interfaces 710, and one or more actuators 712. Processing system 700 can be representative of each computational system disclosed. Each vehicle (e.g., drone, bus, car) disclosed herein can include a separate vehicle processing system configured for autonomous driving in response to receiving a route from a hub processing system. The hub processing system can include each vehicle processing system. The hub processing system and/or each vehicle processing system can be configured to perform each of the operations disclosed herein. In an embodiment, the hub processing system performs the operations shown in FIG. 6 and automatically assigns a vehicle to automatically follow a respective tour.

Processors 702 can include one or more distinct processors, each having one or more cores. Each of the distinct processors can have the same or different structure. Processors 702 can include one or more central processing units (CPUs), one or more graphics processing units (GPUs), circuitry (e.g., application specific integrated circuits (ASICs)), digital signal processors (DSPs), and the like. Processors 702 can be mounted on a common substrate or to different substrates.

Processors 702 are configured to perform a certain function, method, or operation at least when one of the one or more of the distinct processors is capable of executing code (e.g., interpreting scripts), stored on memory 704 embodying the function, method, or operation. Processors 702, and thus processing system 700, can be configured to perform, automatically, any and all functions, methods, and operations disclosed herein.

For example, when the present disclosure states that processing system 700 performs/can perform task “X” (or that task “X” is performed), such a statement should be understood to disclose that processing system 700 can be configured to perform task “X”. Processing system 700 are configured to perform a function, method, or operation at least when processors 702 are configured to do the same.

Memory 704 can include volatile memory, non-volatile memory, and any other medium capable of storing data. Each of the volatile memory, non-volatile memory, and any other type of memory can include multiple different memory devices, located at multiple distinct locations and each having a different structure. Memory 704 can include cloud storage.

Examples of memory 704 include a non-transitory computer-readable media such as RAM, ROM, flash memory, EEPROM, any kind of optical storage disk such as a DVD, a Blu-Ray® disc, magnetic storage, holographic storage, an HDD, an SSD, any medium that can be used to store program code in the form of instructions or data structures, and the like. Any and all of the methods, functions, and operations described in the present application can be fully embodied in the form of tangible and/or non-transitory machine-readable code (e.g., scripts) saved in memory 704.

Input-output devices 706 can include any component for trafficking data such as ports, antennas (i.e., transceivers), printed conductive paths, and the like. Input-output devices 706 can enable wired communication via USB®, DisplayPort®, HDMI®, Ethernet, and the like. Input-output devices 706 can enable electronic, optical, magnetic, and holographic, communication with suitable memory 706. Input-output devices 706 can enable wireless communication via WiFi®, Bluetooth®, cellular (e.g., LTE®, CDMA®, GSM®, WiMax®, NFC®), GPS, and the like. Input-output devices 706 can include wired and/or wireless communication pathways.

Sensors 708 can capture physical measurements of environment and report the same to processors 702. User interface 710 can include displays, physical buttons, speakers, microphones, keyboards, and the like. Actuators 712 can enable processors 702 to control mechanical forces. For example, each vehicle disclosed herein can include a motor (e.g., an engine or an electric motor) and a steering system subject to processing system control to implement an assigned route.

Processing system 700 can be distributed across the hub and one or more of the vehicles. Processing system 700 can have a modular design where certain features have a plurality of the aspects shown in FIG. 7. For example, I/O modules can include volatile memory and one or more processors.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method of performing constrained vehicle routing, the method comprising:
representing variables in an embedded space;
clustering the variables such that cluster elements are compatible with one another;
solving a constrained vehicle routing problem at a level of the clusters;
expanding the constrained vehicle routing solution at the level of the clusters to a level of the variables; and
separately refining each tour of the constrained vehicle routing solution expanded to the level of the variables.

2. The method of claim 1, wherein the clustering the variables is performed iteratively and includes iteratively updating a representative of each cluster based on the cluster elements that belong to the respective cluster.

3. The method of claim 1, wherein the clustering the variables is performed iteratively and includes:
for each cluster, computing a representative of the cluster based on features of the variables belonging to the cluster;
revising cluster membership of the variables based on the cluster representatives; and
for each revised cluster, computing an updated representative based on features of the variables belonging to the revised cluster.

4. The method of claim 3, wherein the representative of each cluster is computed based on coordinates of the variables belonging to the respective cluster.

5. The method of claim 4, wherein the representative of each cluster is a cluster head having coordinates equal to a weighted average of the coordinates of the variables belonging to the respective cluster.

6. The method of claim 1, wherein the constrained vehicle routing solution at the level of the clusters comprises multiple tours, each of the tours beginning and ending with a hub and comprising, therebetween, one or more surrogate nodes.

7. The method of claim 6, wherein each of the surrogate nodes maps to a respective one of the clusters.

8. The method of claim 6, wherein the constrained vehicle routing solution expanded to the level of the variables comprises multiple tours each beginning and ending with the hub and comprising, therebetween, one or more of the variables.

9. The method of claim 1, wherein separately refining each tour of the constrained vehicle routing solution expanded to the level of the variables comprises refining each of the tours in parallel.

10. The method of claim 1, further comprising generating instructions for routing vehicles based on the refined constrained vehicle routing solution, wherein an amount of the variables is greater than one hundred thousand.

11. The method of claim 10, further comprising controlling one or more vehicles based on the generated routing instructions, wherein each of the vehicles is selected from a group consisting of: drones, trucks, buses, airplanes, trains, and boats.

12. The method of claim 10, further comprising controlling a fleet of autonomous drones based on the generated routing instructions.

13. The method of claim 10, further comprising scheduling execution of computational tasks (i) across a high-performance computer cluster and/or (ii) across a graphics processing unit based on the generated routing instructions.

14. A processing system comprising one or more processors, which alone or in combination, are configured to provide for execution of a method comprising:
representing variables in an embedded space;
clustering the variables such that cluster elements are compatible with one another;
solving a constrained vehicle routing problem at a level of the clusters;
expanding the constrained vehicle routing solution at the level of the clusters to a level of the variables; and
separately refining each tour of the constrained vehicle routing solution expanded to the level of the variables.

15. A tangible, non-transitory computer-readable medium having instructions thereon which, upon being executed by one or more processors, alone or in combination, provide for execution of a method comprising:
representing variables in an embedded space;
clustering the variables such that cluster elements are compatible with one another;
solving a constrained vehicle routing problem at a level of the clusters;
expanding the constrained vehicle routing solution at the level of the clusters to a level of the variables; and
separately refining each tour of the constrained vehicle routing solution expanded to the level of the variables.
